(19) United States
(12) Patent Application Publication
(10) Pub. No.: US 2024/0359581 A1
(43) Pub. Date: Oct. 31, 2024

(54) CHARGING SYSTEM

(71) Applicant: ISUZU MOTORS LIMITED, Yokohama-shi (JP)

(72) Inventors: Futoshi YAMANE, Fujisawa-shi (JP); Takuya KIKUCHI, Fujisawa-shi (JP)

(21) Appl. No.: 18/645,706

(22) Filed: Apr. 25, 2024

(30) Foreign Application Priority Data
Apr. 27, 2023 (JP) 2023-073524

(51) Int. Cl. B60L 53/60; H02J 7/00

(52) U.S. Cl. CPC B60L 53/60; H02J 7/00712; B60L 2240/547

(57) ABSTRACT

A charging system is a charging system for supplying power to a battery for driving an electric vehicle from a rapid charger installed outside the electric vehicle, the system including: a constant current charging control section that executes constant current charging control that supplies power from the rapid charger to the battery based on a constant charging current value; and a constant voltage charging control section that, in a case where a voltage value of the battery reaches a predetermined target voltage value and the constant current charging control is stopped, executes constant voltage charging control that supplies power from the rapid charger to the battery two or more times based on a constant charging voltage value.

### CROSS REFERENCE TO RELATED APPLICATIONS

This application is entitled to (or claims) the benefit of Japanese Patent Application No. 2023-073524, filed on Apr. 27, 2023, the disclosure of which including the specification, drawings and abstract is incorporated herein by reference in its entirety.

### TECHNICAL FIELD

The present disclosure relates to a charging system.

### BACKGROUND ART

As a battery charging method, there is known a rapid charging method, for example, which reduces the charging time of the battery.

For example, Japanese Patent Application Laid-Open No. 2015-122866 describes a charging/discharging system for an electric vehicle in which a driving battery mounted on the electric vehicle is rapidly charged with power from a rapid charger installed outside the vehicle.

### CITATION LIST

### Patent Literature

### PTL 1

Japanese Patent Application Laid-Open No. 2015-122866

### SUMMARY OF INVENTION

### Technical Problem

By the way, in the case where a battery is rapidly charged with a rapid charger, charging polarization occurs in the battery. This causes the apparent voltage of the battery to be higher than the actual voltage. A battery management system (BMS) detects the apparent voltage and determines whether the battery is fully charged based on the detected apparent voltage. And, when the battery is determined to be fully charged, the rapid charging is stopped.

In other words, in the case of rapid charging, due to the occurrence of charging polarization in the battery, rapid charging is stopped before the battery is fully charged, leading to the problem of not being able to fully charge the battery.

### Solution to Problem

An object of the present disclosure is to provide a charging system capable of performing a full charge while suppressing the occurrence of charging polarization.

In order to achieve the abovementioned object, a charging system according to the present disclosure is a charging system for supplying power to a battery for driving an electric vehicle from a rapid charger installed outside the electric vehicle, the charging system including: a constant current charging control section that executes constant current charging control that supplies power from the rapid charger to the battery, based on a constant charging current value; and a constant voltage charging control section that, in a case where a voltage value of the battery reaches a predetermined target voltage value and the constant current charging control is stopped, executes constant voltage charging control that supplies the power from the rapid charger to the battery two or more times, based on a constant charging voltage value.

### BRIEF DESCRIPTION OF DRAWINGS

FIG. 1 is a diagram illustrating an example of a charging system according to an embodiment of the present disclosure;

FIG. 2 is a diagram functionally illustrating an example of the charging system according to the embodiment of the present disclosure;

FIG. 3 is a time chart illustrating an example of control of the charging system according to the present embodiment;

FIG. 4 is a time chart illustrating an example of control of a charging system according to a comparative example;

FIG. 5 is a flowchart illustrating an example of control of the charging system according to the present embodiment; and

FIG. 6 is a flowchart illustrating an example of constant voltage charging control of the charging system according to the present embodiment.

### DESCRIPTION OF EMBODIMENTS

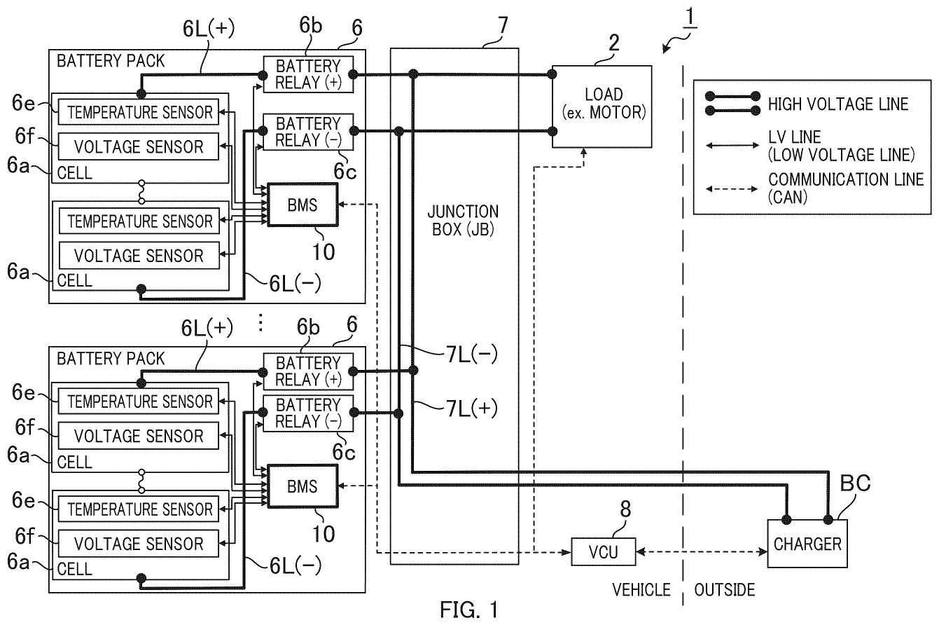

An embodiment of the present disclosure will now be described with reference to the drawings. FIG. 1 is a diagram illustrating an example of charging system 1 for an electric vehicle (EV) according to the embodiment of the present disclosure. Although the following description describes the application of the present disclosure to commercial vehicles such as trucks and buses, the present disclosure is not limited thereto, and may be applied to vehicles such as passenger cars.

As illustrated in FIG. 1, charging system 1 includes external load 2, multiple battery packs 6, junction box 7 (JB), and vehicle control unit 8 (VCU). FIG. 1 also illustrates rapid charger BC disposed outside of the EV. Note that one or more battery packs 6 correspond to a “battery” of the present disclosure. Connecting rapid charger BC to charging system 1 allows power to be supplied to the battery via junction box 7. Also, removing rapid charger BC from charging system 1 cancels the charging of the battery. In the following description, battery packs 6 may simply be referred to as the “battery”.

### External Load 2

External load 2 includes a motor, a heater, a suspension, and the like. The motor is a traveling motor driven by being supplied with power from battery packs 6. The heater is a heater that warms battery packs 6 themselves by being supplied with power from the battery packs 6. The suspension is an apparatus installed in the EV and operates by being supplied with power from the battery packs 6. The suspension includes, for example, a receiving platform lifting apparatus and a refrigerator/freezer.

### Battery Packs 6

Because each of battery packs 6 has the same configuration, one battery pack 6 of battery packs 6 will be described as representative thereof. Battery pack 6 has multiple cells 6a, battery relay (+) 6b, battery relay (−) 6c, and battery management system 10 (BMS).

One terminal of battery relay (+) 6b is connected to the positive terminal of cell 6a via high voltage line 6L (+). The other terminal of battery relay (+) 6b is connected to high voltage line 7L (+). One terminal of battery relay (−) 6c is connected to the negative terminal of cell 6a via high voltage line 6L (−). The other terminal of battery relay (−) 6c is connected to high voltage line 7L (−).

Each cell 6a has temperature sensor 6e and voltage sensor 6f. Temperature sensor 6e detects the cell temperature. Temperature sensor 6e outputs the detection result (cell temperature) to battery management system 10 (BMS). Voltage sensor 6f detects the cell voltage. Voltage sensor 6f outputs the detection result (cell voltage) to battery management system 10.

### Battery Management System 10

Based on each of the input cell temperature and cell voltage, battery management system 10 controls battery relay (+) 6b to make the connection/disconnection between high voltage line 6L (+) and high voltage line 7L (+), and controls battery relay (−) 6c to make the connection/disconnection between high voltage line 6L (−) and high voltage line 7L (−).

For example, based on the open circuit voltage (OCV) of the battery packs 6 and the cell temperature, battery management system 10 (BMS) calculates a state of charge (SOC) by referring to a curve representing the relationship between the SOC set for each cell temperature and the OCV.

### Junction Box 7

Junction box 7 (JB) is disposed between battery packs 6, and external load 2 and charger BC. JB 7 has high voltage line 7L (+) and high voltage line 7L (−). Each of high voltage line 7L (+) and high voltage line 7L (−) is connected to charger BC.

Battery management system 10 (BMS) is connected to vehicle control unit 8 (VCU) via a communication line (CAN). Battery management system 10 obtains the voltage value (cell voltage), cell temperature, and SOC, for example, which are the states of a corresponding one of battery packs 6, whenever a predetermined period of time elapses, and transmits each of the obtained voltage value, cell temperature, and SOC to vehicle control unit 8.

Battery management system 10 (BMS) monitors the states (voltage value, current value, cell temperature, SOC, etc.) of a corresponding one of battery packs 6 and performs control in order to use the corresponding one of battery packs 6 safely and efficiently. Battery management system 10 transmits the states (voltage value, etc.) of the corresponding one of battery packs 6 to vehicle control unit 8 (VCU).

### Vehicle Control Unit 8

Vehicle control unit 8 (VCU) determines the state of the EV and executes control to maintain the EV in an optimal state. Specifically, vehicle control unit 8 controls the motor to stop the EV if it detects an abnormality in the EV. Vehicle control unit 8 also controls the supply of power from battery packs 6 to the motor by changing the voltage between battery packs 6 and the motor.

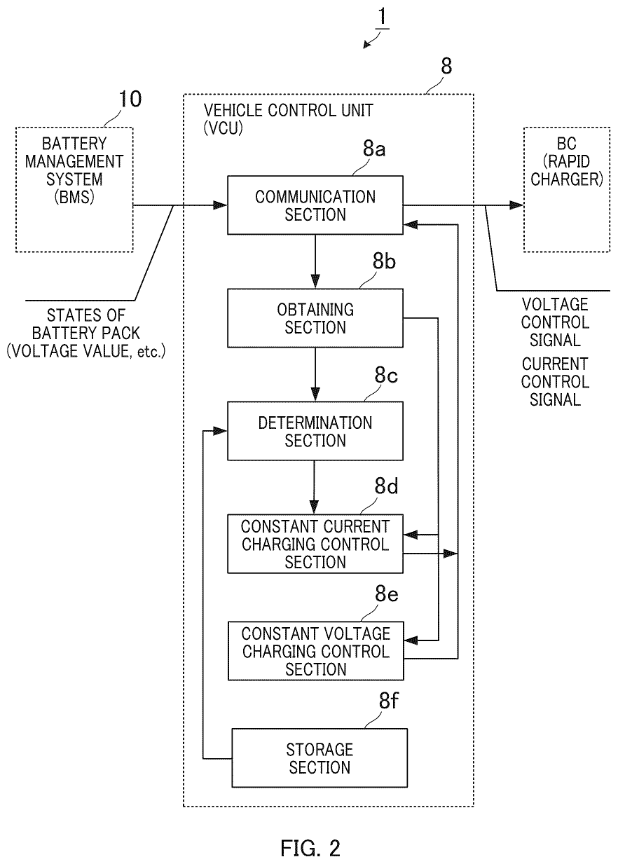

A specific example of charging system 1 will now be described with reference to FIG. 2. FIG. 2 is a diagram functionally illustrating an example of charging system 1.

Vehicle control unit 8 (VCU) includes communication section 8a, obtaining section 8b, determination section 8c, constant current charging control section 8d, constant voltage charging control section 8e, and storage section 8f. In FIG. 2, arrows indicate the major data flow, and there may be data flow not illustrated in FIG. 2. In FIG. 2, functional blocks indicate configurations in units of functions, rather than configurations in units of hardware (apparatuses). As such, the functional blocks illustrated in FIG. 2 may be implemented in a single apparatus or may be implemented separately in multiple apparatuses. The transmission and reception of data between the functional blocks may be performed via any means, such as a data bus, a controller area network (CAN bus), or the like.

### Communication Section 8a

Communication section 8a receives the states (voltage value, etc.) of the battery from battery management system 10.

### Obtaining Section 8b

Obtaining section 8b obtains the voltage value of the battery from battery management system 10 via communication section 8a.

In the case of charging the battery with rapid charger BC, charging polarization occurs in the battery. This causes the apparent voltage of the battery to be higher than the actual voltage. As a result, obtaining section 8b obtains an apparent voltage value that is higher than the actual voltage due to the occurrence of charging polarization. Accordingly, in the present embodiment, obtaining section 8b obtains a first voltage value, which is the voltage value of the battery upon the stopping of constant current charging control. Obtaining section 8b also obtains a second voltage value, which is the voltage value of the battery after a predetermined period of time has elapsed since the stopping of constant current charging control. Note that the fact that the difference between the first voltage value and the second voltage value is within a predetermined range means that no charging polarization is occurring in the battery.

### Storage Section 8f

Storage section 8f is a storage apparatus such as a read only memory (ROM) storing basic input/output system (BIOS) of a computer that realizes vehicle control unit 8, a random access memory (RAM) serving as a work area for vehicle control unit 8, and a hard disk drive (HDD) or a solid state drive (SSD) storing the operating system (OS), application programs, and various types of information referenced during execution of the application programs.

Moreover, storage section 8f stores a predetermined target voltage value. Note that the target voltage value depends on the performance of battery packs 6, the materials constituting battery packs 6, and so forth, and is set based on experiments and simulations. Storage section 8f also stores a predetermined charging current value. Note that the predetermined charging current value depends on the performance of battery packs 6, the materials constituting battery packs 6, and so forth, and is set based on experiments and simulations.

### Determination Section 8c

Determination section 8c determines whether the voltage value of the battery obtained by obtaining section 8b has reached the target voltage value.

Determination section 8c also determines whether the difference between the first voltage value and the second voltage value obtained by obtaining section 8b is within the predetermined range.

Vehicle control unit 8 is a processor such as a central processing unit (CPU) or a graphics processing unit (GPU), and functions as constant current charging control section 8d and constant voltage charging control section 8e by executing a program stored in storage section 8f.

### Constant Current Charging Control Section 8d

Constant current charging control section 8d executes constant current charging control that supplies power from rapid charger BC to the battery based on a constant charging current value. Constant current charging control section 8d stops constant current charging control when the voltage value of the battery reaches the target voltage value. Note that, in the present embodiment, constant current charging control refers to charging control that increases the cell voltage at a constant current value. In the following description, constant current charging may be referred to as “CC charging”.

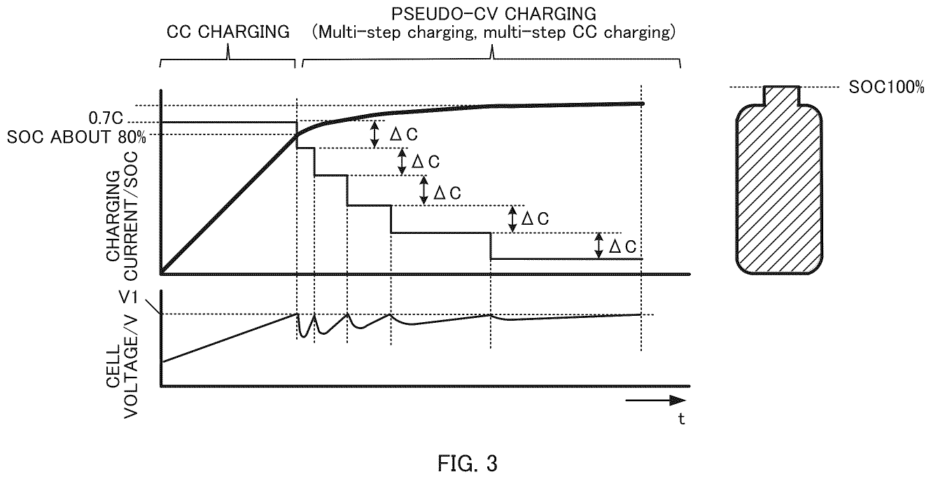

FIG. 3 is a time chart illustrating an example of control of the charging system according to the present embodiment. The upper section of FIG. 3 is a diagram indicating the relationship of each of charging current and SOC to time (t). The vertical axis indicated in the upper section of FIG. 3 represents each of charging current and SOC, while the horizontal axis represents time (t). In the upper section of FIG. 3, the charging current is indicated by a thin line, while the SOC is indicated by a thick line. Also, in the upper section of FIG. 3, the period of constant current control is indicated as “CC charging”. In the upper section of FIG. 3, it is indicated that the charging current remains constant during the period of constant current control (CC charging). Furthermore, it is indicated that the SOC increases to approximately 80% through constant current control.

The lower section of FIG. 3 is a diagram indicating the relationship between cell voltage and time (t). The vertical axis indicated in the lower section of FIG. 3 represents cell voltage (V), while the horizontal axis represents time (t). In the lower section of FIG. 3, it is indicated that the cell voltage is gradually increased during the period of constant current control (CC charging).

### Constant Voltage Charging Control Section 8e

Constant voltage charging control section 8e executes constant voltage charging control in the case where constant current charging control is stopped and determination section 8c determines that the difference between the first voltage value and the second voltage value is within the predetermined range. Note that, in the following description, constant voltage charging may be referred to as “CV charging”.

Constant voltage charging control section 8e executes constant voltage charging control that supplies power from rapid charger BC to the battery two or more times based on a constant charging voltage value. In the present embodiment, constant voltage charging control section 8e repeatedly executes constant voltage charging control a specified number of times. Constant voltage charging control section 8e executes charging control that reduces the charging current while repeatedly executing constant voltage charging control. The charging current value in constant voltage charging control that is repeatedly executed is a numerical value obtained by subtracting a predetermined current value from the charging current value in the previous constant voltage charging control executed before the present constant voltage charging control is executed. The predetermined current value to be subtracted from the charging current value depends on the performance of battery packs 6, the materials constituting battery packs 6, and so forth, and is set based on experiments and simulations.

In the upper section of FIG. 3, constant voltage charging control is indicated as “pseudo-CV charging”. In addition, the predetermined current value to be subtracted from the charging current value in the previous constant voltage charging control is indicated as “AC”. Constant voltage charging control section 8e stops constant voltage charging control in the case where constant voltage charging control is repeated a specified number of times (five times in the upper section of FIG. 3).

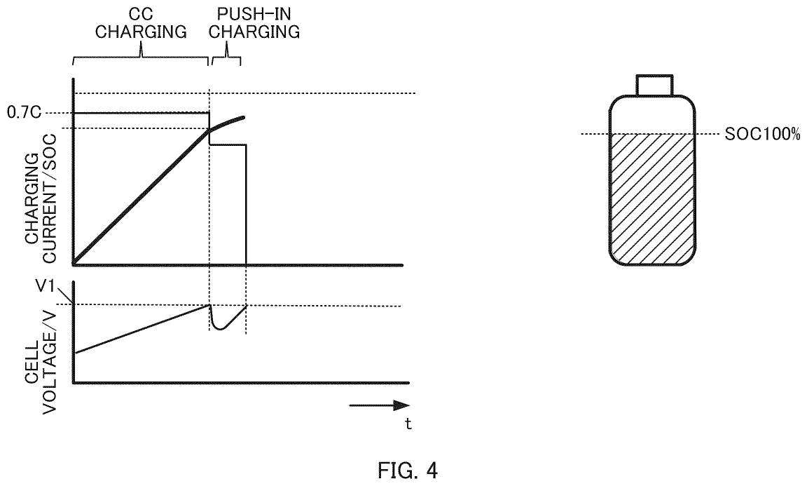

FIG. 4 is a time chart illustrating an example of control of a charging system according to a comparative example. The upper section of FIG. 4 is a diagram indicating the relationship of each of charging current and SOC to time (t). The vertical axis indicated in the upper section of FIG. 4 represents each of charging current and SOC, while the horizontal axis represents time (t). In the upper section of FIG. 4, the charging current is indicated by a thin line, while the SOC is indicated by a thick line. Also, in the upper section of FIG. 4, the period of constant current control is indicated as “CC charging”. In the upper section of FIG. 4, it is indicated that the charging current remains constant during the period of constant current control (CC charging).

The lower section of FIG. 4 is a diagram indicating the relationship between cell voltage and time (t). The vertical axis indicated in the lower section of FIG. 4 represents cell voltage (V), while the horizontal axis represents time (t). In the lower section of FIG. 4, it is indicated that the cell voltage is gradually increased during the period of constant current control (CC charging).

In CC charging, charging polarization occurs. This causes the apparent voltage of the battery to be higher than the actual voltage. A battery management system (BMS) detects the apparent voltage and determines whether the battery is fully charged based on the detected apparent voltage, and sometimes erroneously determines that the battery is fully charged before it is fully charged, thus preventing the battery from being fully charged. As illustrated in the upper section of FIG. 4, in the comparative example, single push-in charging is performed after CC charging, but it is not possible to fully charge the battery.

In response to this, as a result of analyzing and considering experimental data, the applicant has obtained the knowledge that after the stopping of constant current charging control, the apparent voltage drops to nearly the same voltage as the actual voltage. Accordingly, in the present embodiment, a standby time is provided from the stopping of constant current charging control until a predetermined period of time elapses. The applicant has also obtained the knowledge that, even after the stopping of constant voltage charging control, the apparent voltage drops to nearly the same voltage as the actual voltage. Therefore, in the present embodiment, for constant voltage charging control, constant voltage charging control is executed two or more times by gradually reducing the charging current value. This enables the battery to be fully charged while suppressing the occurrence of charging polarization.

Apparatuses that constitute battery management system 10 and vehicle control unit 8 may be configured as a single apparatus, or may be configured as separate apparatuses. Furthermore, it is permissible to be configured with the combination of these apparatuses and another single apparatus. Apparatuses that constitute battery management system 10 and vehicle control unit 8 illustrated in FIG. 2 are realized by at least any one of different processors executing a program. Note that battery management system 10 and vehicle control unit 8 may be realized by computational resources such as processors and memories, for example.

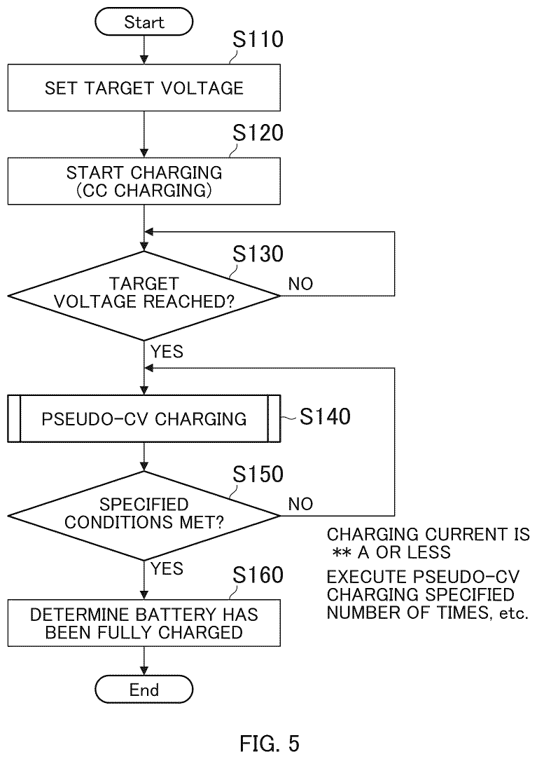

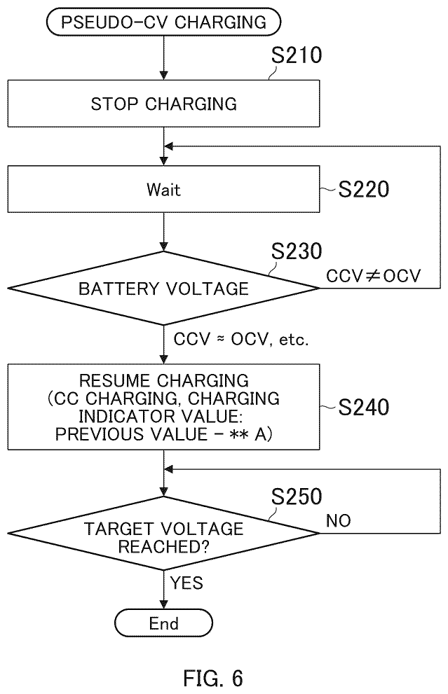

An example of the operation of vehicle control unit 8 (VCU) according to the present embodiment will now be described with reference to FIGS. 5 and 6. FIG. 5 is a flowchart illustrating an example of control of the charging system according to the present embodiment. The flow illustrated in FIG. 5 starts when charger BC is connected to charging system 1.

First, in step S110, vehicle control unit 8 sets a target voltage.

Next, in step S120, constant current charging control section 8d starts constant current charging control (CC charging).

Next, in step S130, determination section 8c determines whether the voltage value of the battery has reached the target voltage. If the voltage value of the battery has reached the target voltage (step S130: YES), the process transitions to constant voltage charging control. If the voltage value of the battery has not reached the target voltage (step S130: NO), the process returns to before step S130.

In step S140, constant voltage charging control (pseudo-CV charging) is executed (see FIG. 6).

Next, in step S150, constant voltage charging control section 8e determines whether the specified conditions have been met. Specifically, constant voltage charging control section 8e determines whether the charging current is less than or equal to a predetermined current and whether constant voltage charging control has been executed a specified number of times. If the specified conditions have been met (step S150: YES), the process transitions to step S160. If the specified conditions have not been met (step S150: NO), the process returns to before step S140.

In step S160, constant voltage charging control section 8e determines that the battery has been fully charged, and ends the constant voltage charging control. After that, the flow also ends.

FIG. 6 is a flowchart illustrating an example of constant voltage charging control of the charging system according to the present embodiment. In the flow illustrated in FIG. 6, pseudo-CV charging is started when the voltage value of the battery has reached the target voltage in the constant current charging control (step S130 illustrated in FIG. 5: YES).

First, in step S210, the constant current charging control is stopped.

Next, in step S220, constant voltage charging control section 8e stands by for a predetermined period of time (“Wait” indicated in FIG. 6).

Next, in step S230, determination section 8c determines whether the difference between the first voltage value and the second voltage value is within the predetermined range. If the difference is within the predetermined range (step S230: YES), the process transitions to step S240. If the difference is not within the predetermined range (step S230: NO), the process returns to before step S230. In FIG. 6, the first voltage value, which is the apparent voltage, is indicated as “CCV”, while the second voltage value, which is the actual voltage, is indicated as “OCV”. In addition, in FI6. 6, the fact that the difference is within the predetermined range is indicated as “CCV≈OCV”, while the fact that the difference is outside the predetermined range is indicated as “CCV≠OCV”.

In step S240, constant voltage charging control section 8e resumes the constant voltage charging control. Note that a charging indicator value (charging current value) in the resumed constant voltage charging control is a numerical value obtained by subtracting a predetermined charging value from the previous value (charging current value) in the previous constant voltage charging control. In FIG. 6, charging based on the charging indicator value is indicated as “CC charging”. In addition, the numerical value obtained by subtracting the predetermined charging value from the previous value is indicated as “previous value−**A”.

Next, in step S250, determination section 8c determines whether the voltage value of the battery has reached the target voltage. If the voltage value of the battery has reached the target voltage (step S250: YES), the flow ends. If the voltage value of the battery has not reached the target voltage (step S250: NO), the process returns to before step S250.

Charging system 1 according to the above-described embodiment is a charging system that supplies power to a battery for driving an EV from rapid charger BC installed outside the EV, the system including: constant current charging control section 8d that executes constant current charging control that supplies power from rapid charger BC to the battery based on a constant charging current value; and constant voltage charging control section 8e that, in a case where a voltage value of the battery reaches a predetermined target voltage value and the constant current charging control is stopped, executes constant voltage charging control that supplies power from rapid charger BC to the battery two or more times based on a constant charging voltage value.

With the above-described configuration, it is possible to fully charge the battery while suppressing the occurrence of charging polarization by executing constant voltage charging control two or more times after executing constant current charging control.

In addition, charging system 1 according to the above-described embodiment further includes: obtaining section 8b that obtains a first voltage value that is a voltage value of the battery upon stopping when the constant current charging control is stopped, and a second voltage value that is a voltage value of the battery after a predetermined period of time has elapsed since the stopping; and determination section 8c that determines whether a difference between the obtained first voltage value and the obtained second voltage value is within a predetermined range, wherein constant voltage charging control section 8e executes constant voltage charging control based on a predetermined charging current value in a case where the difference is determined to be within the predetermined range. This makes it possible to suppress the occurrence of charging polarization because constant voltage charging control is executed after the apparent voltage of the battery drops to nearly the same voltage as the actual voltage.

In addition, in charging system 1 according to the above-described embodiment, the charging current value in the constant voltage charging control executed two or more times is a numerical value obtained by subtracting a predetermined current value from the charging current value in previous constant voltage charging control executed before present constant voltage charging control is executed. By gradually reducing the charging current value, constant voltage charging control can be executed two or more times, making it possible to fully charge the battery.

In addition, all the above-described embodiments merely indicate examples of embodiments for implementing the present disclosure, and the technical scope of the present disclosure should not be construed as limited by these embodiments. That is, the present disclosure may be implemented in a variety of ways without departing from the gist or main features thereof.

The present disclosure is suitable for use in electric vehicles equipped with charging systems that are required to perform a full charge while suppressing the occurrence of charging polarization.

1. A charging system for supplying power to a battery for driving an electric vehicle from a rapid charger installed outside the electric vehicle, the charging system comprising:
a constant current charging control section that executes constant current charging control that supplies power from the rapid charger to the battery, based on a constant charging current value; and
a constant voltage charging control section that, in a case where a voltage value of the battery reaches a predetermined target voltage value and the constant current charging control is stopped, executes constant voltage charging control that supplies the power from the rapid charger to the battery two or more times, based on a constant charging voltage value.

2. The charging system according to claim 1, further comprising:
an obtaining section that obtains a first voltage value that is a voltage value of the battery upon stopping when the constant current charging control is stopped, and a second voltage value that is a voltage value of the battery after a predetermined period of time has elapsed since the stopping; and
a determination section that determines whether a difference between the obtained first voltage value and the obtained second voltage value is within a predetermined range,
wherein the constant voltage charging control section executes the constant voltage charging control based on a predetermined charging current value in a case where the difference is determined to be within the predetermined range.

3. The charging system according to claim 2, wherein the charging current value in the constant voltage charging control executed two or more times is a numerical value obtained by subtracting a predetermined current value from the charging current value in previous constant voltage charging control executed before present constant voltage charging control is executed.
